(19) United States
(12) Patent Application Publication
(10) Pub. No.: US 2014/0210944 A1
(43) Pub. Date: Jul. 31, 2014

(54) METHOD AND APPARATUS FOR CONVERTING 2D VIDEO TO 3D VIDEO

(71) Applicant: Samsung Electronics Co., Ltd., Gyeonggi-do (KR)

(72) Inventors: Moon-Sik JEONG, Gyeonggi-do (KR); Nipun KUMAR, Bangalore (IN); Anshul SHARMA, Bangalore (IN); Armin MUSTAFA, Bangalore (IN); Karan SEHGAL, Bangalore (IN); Kiran NANJUNDAIYER, Bangalore (IN); Nikhil KRISHNAN, Bangalore (IN); Revanth PAM, Bangalore (IN); Abhijit LADE, Bangalore (IN); Abhinandan BANNE, Bangalore (IN); Biju NEYYAN, Bangalore (IN); Prakash BHAGAVATHI, Bangalore (IN); Ranjith THARAYIL, Bangalore (IN)

(73) Assignee: Samsung Electronics Co., Ltd., Gyeonggi-do (KR)

(21) Appl. No.: 14/168,403

(22) Filed: Jan. 30, 2014

(30) Foreign Application Priority Data
Jan. 30, 2013 (IN) 403/CHE/2013
May 16, 2013 (KR) 1020130055774

(51) Int. Cl. H04N 13/00

(52) U.S. Cl. CPC H04N 13/0022
USPC 348/43

(57) ABSTRACT

A method and apparatus are provided for converting a Two-Dimensional (2D) video to a Three-Dimensional (3D) video is disclosed. The method includes detecting a shot including similar frames in the 2D video; setting a key frame in the shot; determining whether a current frame is the key frame; when the current frame is the key frame, performing segmentation on the key frame, assigning a depth to each segmented object in the key frame; and when the current frame is not the key frame, performing the segmentation on non-key frames, and assigning the depth to each segmented object in the non-key frames.

### PRIORITY

This application claims priority under 35 U.S.C. §119(a) to Indian Patent Application Serial No. 403/CHE/2013, which was filed in the Indian Intellectual Property Office on Jan. 30, 2013, and to Korean Patent Application Serial No. 10-2013-0055774, which was filed in the Korean Intellectual Property Office on May 16, 2013, the content of each of which is incorporated herein by reference.

### BACKGROUND OF THE INVENTION

1. Field of the Invention

The present invention relates generally to Three-Dimensional (3D) video and more particularly, to the conversion of Two-Dimensional (2D) video to the 3D video and a User Interface (UI) for the same.

2. Description of the Related Art

With the recent increase of 3D videos, extensive research has been conducted on methods for generating 3D video. Since the initial study stage of 3D graphics, the ultimate objective of researchers is to generate a graphical image as real as a real image. Therefore, studies have been conducted using polygonal models in the traditional rendering field, and as a result thereof, modeling and rendering technology has been developed to provide a very realistic 3D environment. However, generation of a complex model takes a lot of effort and time from experts. Moreover, a realistic, complex environment utilizes a huge amount of information (data), thereby causing low efficiency in storage and transmission.

To avoid this problem, many 3D image rendering techniques have been developed. In generating 3D video, conventionally, depth information should is assigned to each object in each frame included in the video, and therefore, this operation takes a long time and involves many computations for each frame. The time and computations are further increased because object segmentation is performed for each frame included in the video. Further, the above-described segmentation or depth assignment is performed directly and there is no UI for effectively reducing time and computations required for converting a 2D video to a 3D video.

### SUMMARY OF THE INVENTION

Accordingly, the present invention is designed to address at least the problems and/or disadvantages described above and to provide at least the advantages described below.

An aspect of the present invention is to provide a method for converting a 2D video to a 3D video.

Another aspect of the present invention is to provide a method for providing a UI for converting the 2D video to the 3D video.

Another aspect of the present invention is to provide a method that effectively reduces an overall time and a number of computations for 2D-to-3D video conversion by performing segmentation or assigning depth information to a specific video frame from among a plurality of video frames.

In accordance with an aspect of the present invention, a method for converting a 2D video to a 3D video is provided, which includes detecting a shot including similar frames in the 2D video; setting a key frame in the shot; determining whether a current frame is the key frame; when the current frame is the key frame, performing segmentation on the key frame, assigning a depth to each segmented object in the key frame; and when the current frame is not the key frame, performing the segmentation on non-key frames, and assigning the depth to each segmented object in the non-key frames.

In accordance with another aspect of the present invention, an apparatus is provided for converting a 2D video to a 3D video. The apparatus includes a processor; and a non-transitory memory having stored therein a computer program code, which when executed controls the processor to: detect a shot including similar frames in the 2D video; set a key frame in the shot; determine whether a current frame is the key frame; when the current frame is the key frame, perform segmentation on the key frame, assign a depth to each segmented object in the key frame, and store a depth map associated with the key frame; and when the current frame is not the key frame, perform the segmentation on non-key frames, assign the depth to each segmented object in the non-key frames.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a flow diagram illustrating a process of converting 2D video to 3D video, according to an embodiment of the present invention;

FIG. 2 is a flow diagram illustrating a process of shot boundary detection and key frame selection, according to an embodiment of the present invention;

FIG. 3 is a flow diagram illustrating a process of object detection, according to an embodiment of the present invention;

FIG. 4 is a flow diagram illustrating a process of depth assignment, according to an embodiment of the present invention;

FIG. 5 is a flow diagram illustrating a process of segment tracking, according to an embodiment of the present invention;

FIG. 6 is a flow diagram illustrating a process of depth propagation, according to an embodiment of the present invention;

FIGS. 7A to 7O illustrate layouts of a Graphical UI (GUI) for a user-guided conversion, according to an embodiment of the present invention;

FIGS. 8A to 8P illustrate layouts of a GUI for a user-guided conversion, according to an embodiment of the present invention; and

FIG. 9 is a block diagram illustrating an apparatus for converting 2D video to 3D video, according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

The various embodiments described below convert 2D video to 3D video using a semi-automatic approach, by providing a UI through which a user can effectively reduce an overall time and a number of computations for the 2D-to-3D video conversion, by performing segmentation or assigning depth information to a specific video frame among a plurality of video frames included in the 2D video. For example, the video conversion may be performed in any touch screen device, mobile phone, Personal Digital Assistant (PDA), laptop, tablet, desktop computer, etc.

In accordance with an embodiment of the present invention, a method is provided for converting 2D video to 3D video, in which a key frame to be segmented is determined from among the 2D video frame of the 2D video. The key frame is segmented by separating an object in the key frame and storing information about the segmentation. A segmented 2D video is generated by segmenting the 2D video frame, except for the key frame, in the same manner as the key frame is segmented, based on the stored segmentation information. Thereafter, the segmented 2D video is converted to 3D video.

In accordance with an embodiment of the present invention, depth information for the separated object of the key frame is received and stored on an object basis. The 3D video is generated by assigning the stored depth information commonly to 2D video frames, except the key frame.

In accordance with an embodiment of the present invention, a UI is provided for segmenting 2D video including 2D video frames, in which a key frame to be segmented is determined from among the video frames. The UI also provides an image including a segmentation activation area for separating an object in the key frame and an image of the key frame is provided. A segmentation activation area selection input and the object selection input is used for separating the object in the key frame by segmentation are received. The key frame is segmented based on the object selection input. Information about the segmentation is stored, and a segmented 2D video is generated by segmenting at least one 2D video frame, except the key frame, in the same manner as the key frame, based on the segmentation information.

In accordance with an embodiment of the present invention, an image that includes a tool box for assigning depth information to the separated object included in the key frame and an image of the key frame is provided. An input for selecting a depth assignment item from the tool box is received, and depth information for the separated object included in the key frame is received and stored on an object basis. The 3D video is generated by commonly assigning the stored depth information to objects included in 2D video frames, except the key frame. The depth information includes gradually changing depth information assigned to the specific object with respect to an extension line having a depth gradient relative to the depth information of each of the depth assignment start and end points of the specific one object, where the extension line is perpendicular to a line connecting the depth assignment start and end points of the specific object.

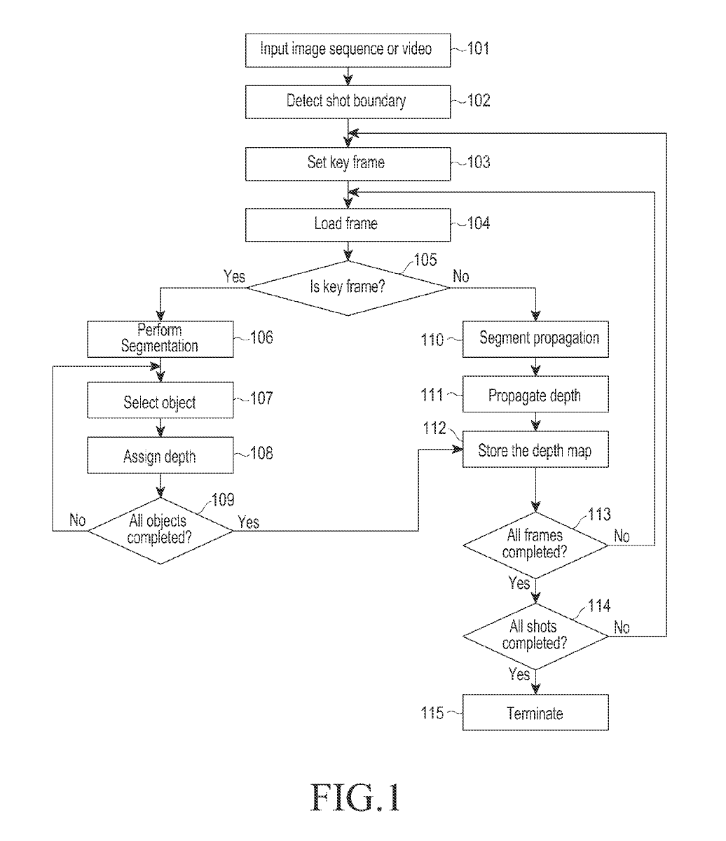

FIG. 1 is a flow diagram illustrating a process of converting 2D video to 3D video, according to an embodiment of the present invention.

Referring to FIG. 1, a user inputs a sequence of images or a 2D video in step 101. For example, the 2D video includes a number of 2D video frames conforming to a specific standard, such as the H.264 video compression standard. In the 2D video, a number of shots are joined together to form a scene, and a number of scenes joined together form the video.

The 2D video often includes similar 2D video frames in which a difference between pixel positions in the images is less than or equal to a predetermined threshold. Based on relationship, shot boundaries are detected that indicate a plurality of shots for grouping similar 2D video frames in step 102. A key frame is set in one of the shots in step 103.

In an embodiment, the user could not find any shot boundary in the shots.

Herein, a key frame is a frame that needs to be segmented. The segments are propagated to the non key frames. Depth values are assigned on key frames and propagated to the non key frames. For example, a key frame can be the first frame of a shot or may be selected according to an external key frame selection input.

In step 104, a current frame of a shot in the 2D video is loaded. In step 105, the process determines whether the current frame is the key frame or a non key frame. For example, the key frame can be determined using statistics based on pixel information of each input 2D video frame.

When the current frame is the key frame, the key frame is segmented into smaller regions called segments in step 106. The segments aid in depth assignment.

In accordance with an embodiment of the present invention, segmentation involves distinguishing one or more objects included in the key frame from each other. For example, the segmentation may detect contours of objects included in the key frame.

Based on the segmentation, the user to selects a desired object or objects in step 107.

In step 108, the user assigns a depth to each selected object. Various strategies allow the user to assign depth realistically.

In accordance with an embodiment of the present invention, the segmentation can be automatically performed or triggered upon receipt of an external object selection input. Further, in the segmentation, at least one object is identified based on at least one of edges, corner points, and blobs included in the 2D video frame.

An edge may be composed of points forming the boundary line of an area having different pixel values, e.g., a set of points with first-order partial derivative values being non-zeroes in a captured image. The partial derivative of a visible-light captured image may be calculated and an edge may be acquired using the partial derivative.

Corner points may be a set of points which are extremums of the captured image. The corner points may have zero first-order partial derivative values and non-zero second-order partial derivative values in the captured image. In addition, a point that cannot be differentiated in the captured image may be considered as an extremum, and thus, determined as a corner point. The corner points may be Eigen values of a Hessian Matrix introduced for Harris corner detection. The entire Hessian Matrix may be composed of the second-order partial derivatives of a continuous function.

A blob is an area having larger or smaller pixel values than in its vicinity. For example, the blob may be obtained using the Laplacian or Laplace operator of the second-order partial derivative of each dimension (x-dimension and y-dimension) in a visible-light captured image.

In step 109, the process determines whether the assigning of depths has been completed for all the objects in the key frame. When there are more objects left, then process returns to the object selection in step 107.

When the current frame is not the key frame in step 105, the process propagates the segments to the un-segmented non-key frames in step 110 and propagates depth in step 111.

After depths are assigned for all of the objects in the segmented key frame in step 109 or the depth is propagated in the segmented non-key frame in step 111, the depth map for each frame (key or non-key) is stored in step 112.

In step 113, the process determines if operations on all of the frames of the shot are completed. If the operations on all of the frames are not completed, then the process returns to the step 104, where a next frame is loaded. Otherwise, if the operations on all of the frames are completed, then the process determines if operations on all of the shots are completed. If there are any shots for which the operation has not been performed, then the process returns to step 103, wherein a key frame is set a next shot.

After operations have been performed for all of the detected shots in step 114, the process terminates.

The various steps in FIG. 1 may be performed in the order presented, in a different order, or simultaneously. Further, in some embodiments, some of the steps illustrated in FIG. 1 may be omitted.

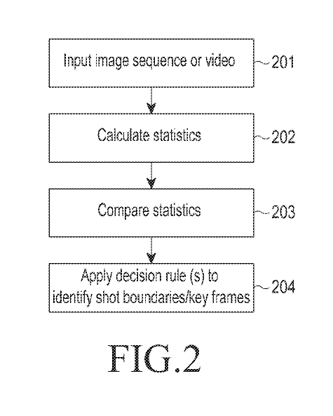

FIG. 2 is a flow diagram illustrating a process of shot boundary detection and key frame selection, according to an embodiment of the present invention.

Referring to FIG. 2, a user inputs an image sequence or a 2D video in step 201. In step 202, image statistics are calculated for the input image sequence or the 2D video. For example, the image statistics can be a color, a Hue Saturation Value (HSV), or a Grayscale histogram representing properties of the image.

For example, a histogram based on color information, HSV information, or grayscale information of each 2D video frame may be analyzed and a 2D video frame satisfying a specific condition regarding such a histogram may be selected as a key frame. For example, the histograms of 2D video frames may be averaged and the 2D video frame having the smallest difference from the average may be selected as a key frame.

The above-described key frame selection methods are purely exemplary and a key frame can be determined according to various rules.

In step 203, the statistics of nearby frames are compared to find differences between the images. For a key frame, the method compares the statistics of each frame with nearby or all the other frames in a shot to find differences or a sum of differences between the images.

A shot boundary may be determined by comparing 2D video frames included in a 2D video. The shot boundary may be detected by grouping similar 2D video frames having comparison results that are less than or equal to a threshold into a shot.

In accordance with an embodiment of the present invention, comparison results are based on at least one of a color histogram, an HSV histogram, and grayscale histogram of the video frame. In step 204, a decision rule is applied to select the shot boundaries and key frames based on the identified differences of the images.

The various steps in FIG. 2 may be performed in the order presented, a different order, or simultaneously. Further, some steps illustrated in FIG. 2 may be omitted.

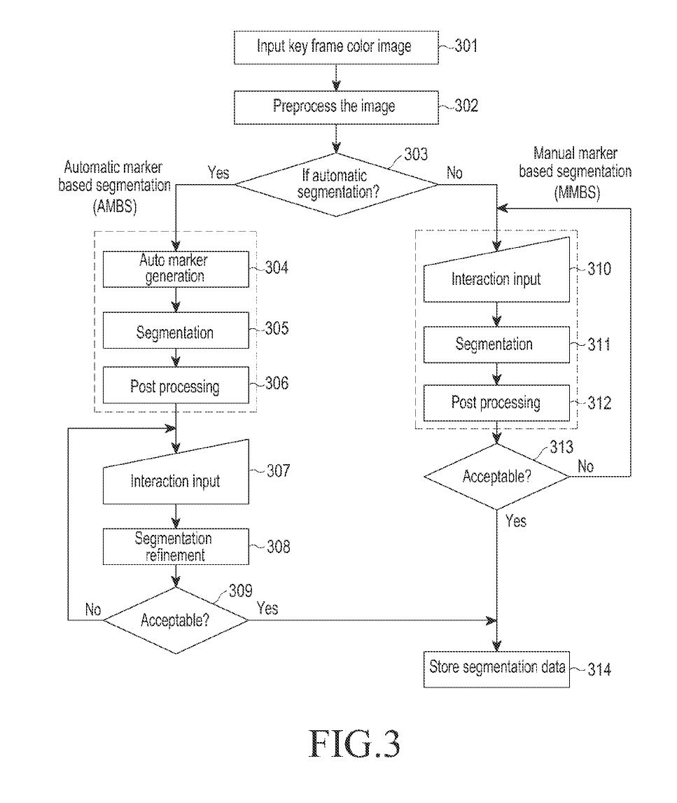

FIG. 3 is a flow diagram illustrating a process of object detection, according to an embodiment of the present invention.

Referring to FIG. 3, a user inputs a key frame color image in step 301. For example, the key frame includes a plurality of objects. An object selection input may be generated by drawing lines inside one or more objects.

In step 302, the key frame image is preprocessed by smoothing the image using a Gaussian/median/bilateral filter, gray image conversion, and gradient image conversion.

In step 303, the user selects automatic segmentation or manual segmentation.

When automatic segmentation is selected by the user, Automatic Marker Based Segmentation (AMBS) is performed. More specifically, in step 304, markers are automatically generated by finding a local minima in the preprocessed image. In step 305, segmentation is performed using the available markers, e.g., using any marker based segmentation algorithm such as Watershed, Graph Cut, biased Normalized Cut, etc. In step 306, post processing is performed, which smooths contours obtained by the segmentation in step 305. For example, active contour, Laplacian smoothening, and/or Hysteresis smoothening may be used for post processing.

In step 307, the user enters an input for auto marker based segmentation, which adjusts the level of segmentation that can vary from a maximum number of segments to a minimum number of segments, as well as modifying the weight of each contour enhanced relevant edge or suppress unnecessary edges.

In step 308, segmentation refinement re-segments the image based on the user inputs from step 307.

In step 309, the user previews the result, and if it is not acceptable, the process returns to step 307.

When manual segmentation is selected in step 303, the user inputs the markers for Manual Marker Based Segmentation (MMBS) in step 310. In step 311, segmentation is performed using the available markers, e.g., using any marker based segmentation algorithm.

In step 312, post processing is performed to smooth contours obtained by the segmentation.

In step 313, the user previews the result, and if it is not acceptable, the process returns to step 310.

AMBS provides an initial segmentation without user interaction, which can later be modified via user interaction in step 307. MMBS requires user interaction.

If the results are acceptable in step 309 or 313, the segmentation result is stored in step 314.

In accordance with an embodiment of the present invention, a segmented 2D video may be generated by segmenting a 2D video frame, other than the key frame, i.e., a non-key frame, in the same manner as the key frame is segmented, based on the stored segmentation result in step 314.

The various steps illustrated in FIG. 3 may be performed in the order presented, in a different order, or simultaneously. Further, some steps illustrated in FIG. 3 may be omitted.

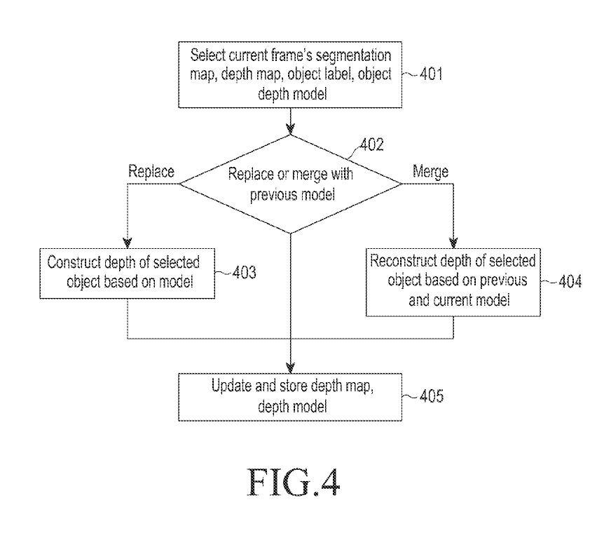

FIG. 4 is a flow diagram illustrating a process of depth assignment, according to an embodiment of the present invention.

Referring to FIG. 4, in step 401, a current frame's segmentation map, depth map, depth model file, object label, and object depth model are selected in step 401. In step 402, the process identifies an existing depth model for the selected object in the depth model file, and then either replaces the existing depth model with the selected object depth mode or merges the selected object depth mode with the existing depth model.

If the user selects to replace the existing depth model, the depth for the selected object is constructed based on the selected object depth model, and the depth of the selected object is replaced/assigned with the current depth model in step 403. However, if the user selects to merge the selected object depth mode with the existing depth model, the depth model of the selected object is retrieved from the depth model file, and the depth is reconstructed based on current and existing depth models using a surface function derived from two (or more) depth models in step 404.

In step 405, the depth map and depth model file are updated and stored.

The various steps illustrated in FIG. 4 may be performed in the order presented, in a different order, or simultaneously. Further, some steps illustrated in FIG. 4 may be omitted.

Examples of the depth models include Planar, Gradient, Convex, and Hybrid, descriptions of which are provided below.

Planar—Planar templates can be used to create a depth map for uniform and flat objects, e.g., a disk or a wall in an X-Y plane.

Gradient—Gradient template is used to create depth maps where a uniform gradual depth variation is used, e.g., a floor or walls of a room, which are not in an X-Y plane.

Convex—In this model, a depth value is assigned to a pixel based on the proximity to the object boundary. This model is an approximate model for objects like balls, a human body, etc.

Hybrid—The depth assignment model is hybrid when more than one depth model has been used for the same object using a merging criteria or when a pixel level modification has been performed by the user for an object depth map.

In accordance with an embodiment of the present invention, the method handles Gradual Transitions at shot boundaries. In this case, a depth map of a predefined set of frames, just before starting and right after ending a transition shot, are subjected to smoothening that gradually reduces a depth disparity associated with frames at transition shot boundaries. As a result, a better viewing experience is provided by eradicating a sudden change in depths (of objects) at transition shot boundaries.

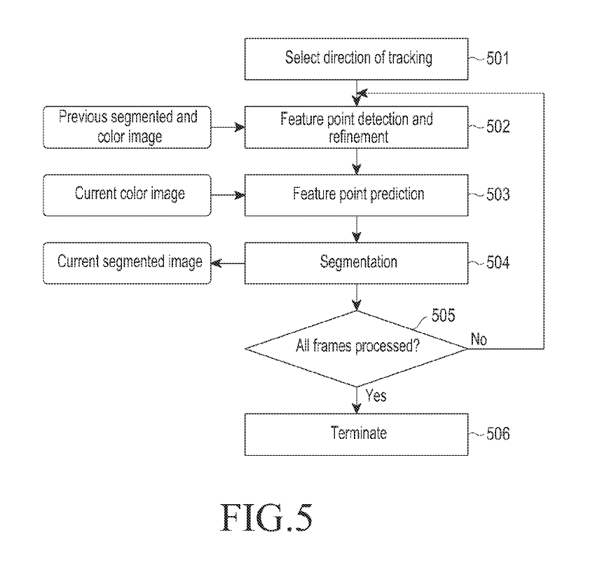

FIG. 5 is a flow diagram illustrating a process of segment tracking, according to an embodiment of the present invention.

Referring to FIG. 5, in step 501, a user selects a direction for tracking, such as forward, backward, or bidirectional. The user gives the input of the objects in the frames to be tracked and the input to this block is the segmented key frame and the original key frame for preprocessing.

In step 502, feature points are detected in a region of interest, i.e., in and on the object.

For example, feature point detection may be performed by finding feature points using a Shi and Tomasi definition, by placing random points on the object such that it does not come on contour of the object, or by eroding the object followed by detection of uniformly spaced points on the contour of the eroded object.

In step 503, a feature point is predicted using a current color image or an immediate non-key frame according to the direction of tracking.

Further, optical flow tracking is performed to predict the feature points in the next frame using the information of the previous feature points. The optical flow method used for prediction has limitation in terms of motion and color similarity. To overcome this limitation, a refinement step to exclude such feature points which so that segmentation results do not get affected.

In step 504, segmentation is performed for the next frame. The final set of refined feature points is used as markers (seed points) for watershed segmentation. Each of these points carries label information from the previously segmented key frame to ensure that the object correspondence between frames is maintained. Post segmentation propagation, user has option to refine the results interactively.

In step 505, the process determines if all the frames specified by user are segmented or not. If not, the returns to step 502 to repeat the above-described steps for a next frame. However, when all the frames specified by user are segmented, a set of segmented non-key frames are output and the process is terminated in step 506.

The various steps illustrated in FIG. 5 may be performed in the order presented, in a different order, or simultaneously. Further, some steps illustrated in FIG. 5 may be omitted.

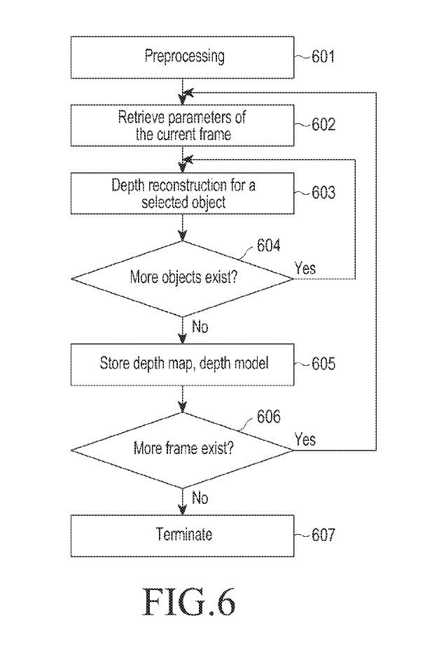

FIG. 6 is a flow diagram illustrating a process of depth propagation, according to an embodiment of the present invention.

Referring to FIG. 6, inputs such as depth curve (optional) and for unidirectional propagation where depth variation is described by the depth curve. Depth maps and corresponding depth model files for all frames from start to end frames (if exists) are given as input. For unidirectional propagation, the start frame, and for bidirectional propagation, both start frame and end frame depth maps and corresponding depth model files are used. Also, object labels of the objects to be propagated are given as input. Direction (uni/bi-directional propagation), start frame for depth propagation, end frame for depth propagation are provided as input.

Based on the input, the process preprocessing a generic depth model for each object based on the available data in step 601. In step 602, parameter segmentation maps, depth maps, and feature points for the current frame are retrieved. In step 603, a depth for each object is reconstructed based on information gathered various ways, such as interpolation, object area, depth model, feature point tracking, homography, etc.

If more objects exist for depth propagation in step 604, the process returns to step 603.

If no more objects exist for depth propagation in step 604, the depth maps and the depth model files of the current working frame are stored in step 605.

In step 606, the process determines whether more frames exist in the video. If yes, then the process returns to the step 602. However, if no more frames exist in the video, the process terminates in step 607.

The various illustrated in FIG. 6 may be performed in the order presented, in a different order, or simultaneously. Further, some steps illustrated in FIG. 6 may be omitted.

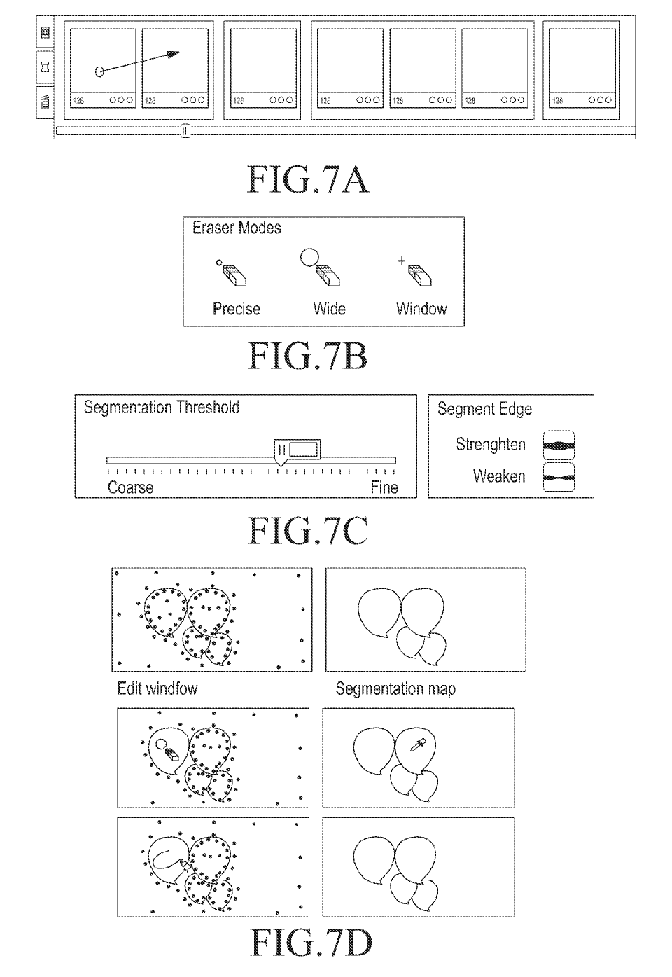

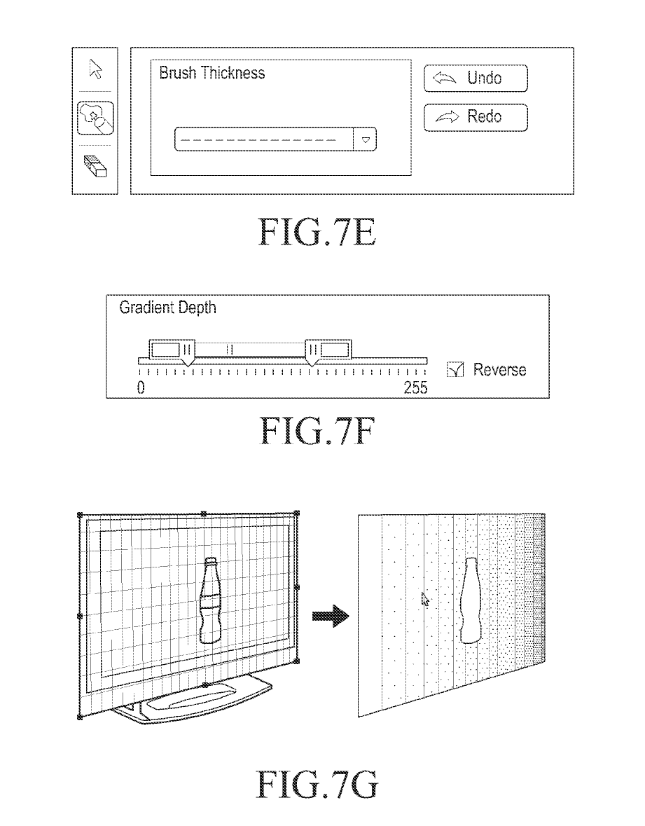

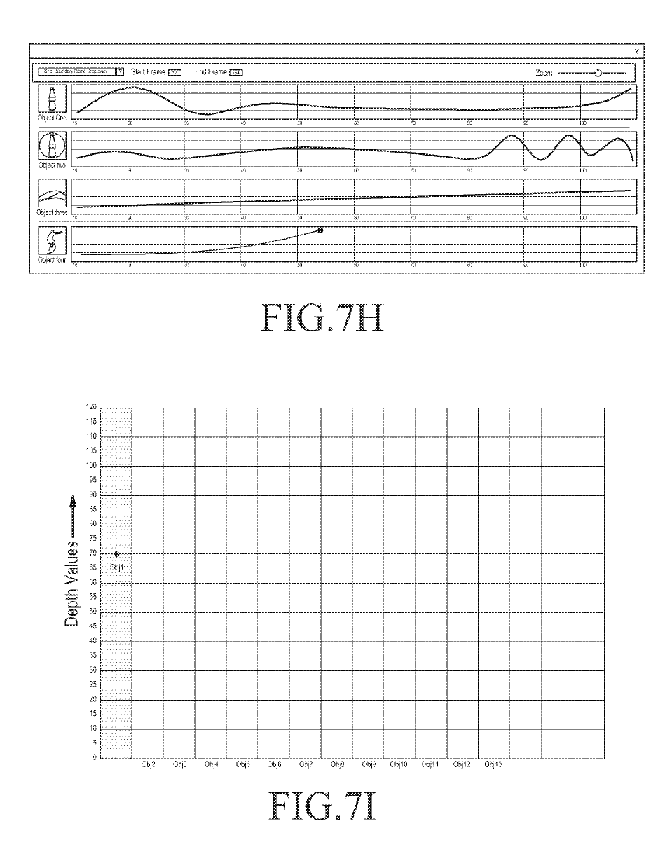

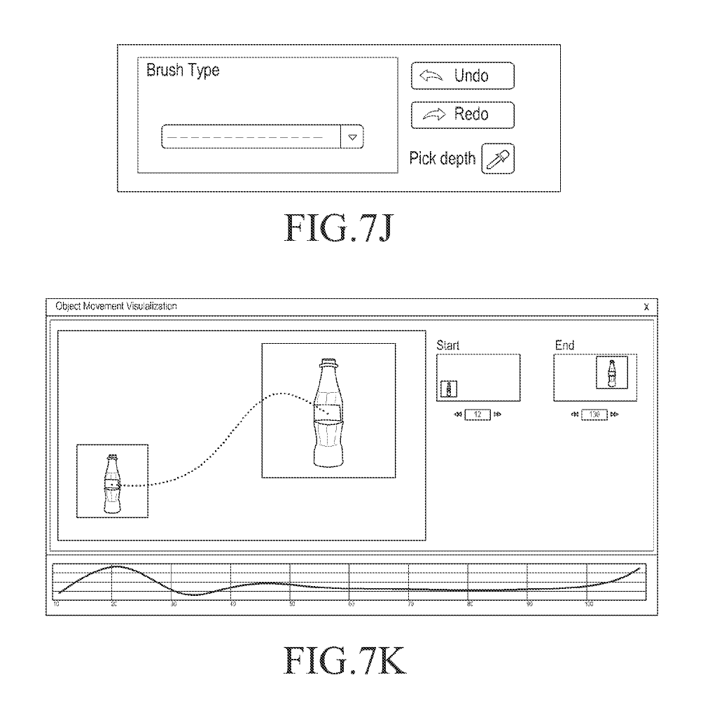

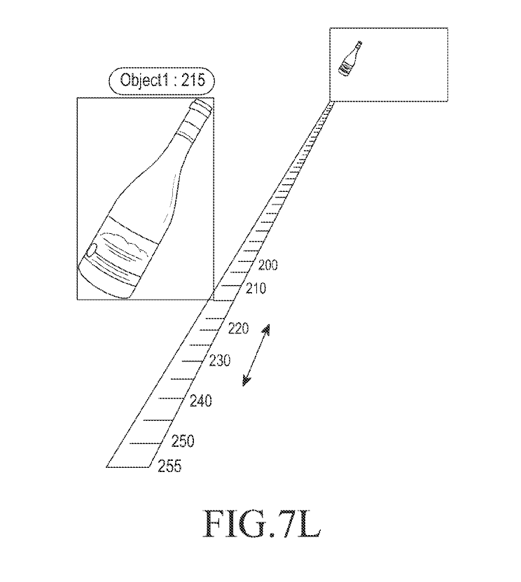

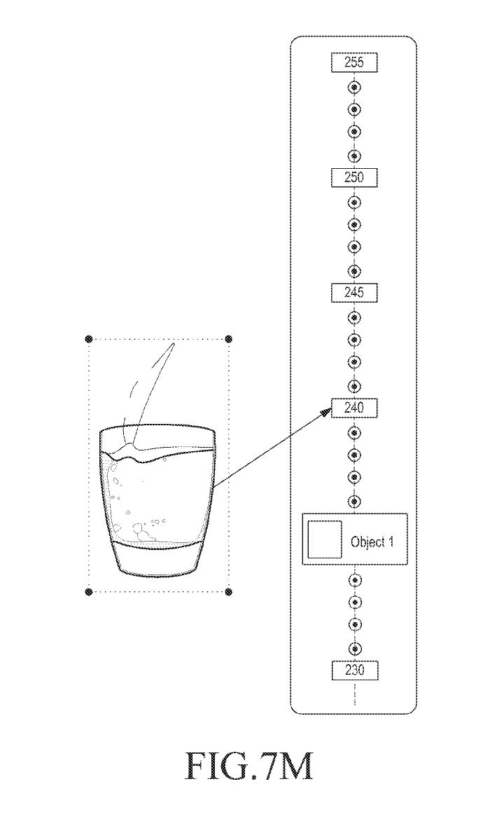

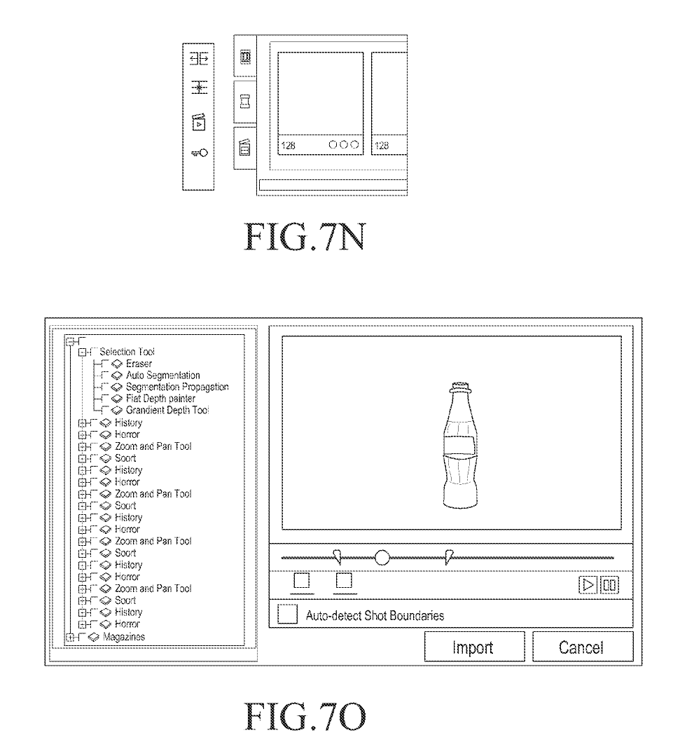

FIGS. 7A to 7O illustrate layouts of a Graphical UI (GUI) for a user-guided conversion, according to an embodiment of the present invention.

Specifically, FIG. 7A illustrates interactions for propagation of segments and depth values. Initially, the UI shown in FIG. 7A allows the user to click and drag from a source frame to a target frame to trigger a propagation command. Whether to propagate segment, depth values, or both will depend upon the context defined for the currently active tool. For example, when the user's current tool is a depth assigning tool, depth propagation is triggered.

When the current tool is a segmentation tool (for example, a marker tool), segmentation propagation is triggered.

When the current tool is section tool, both segmentation and depth propagation can be trigged.

In accordance with an embodiment of the present invention, modifier keys can be used in conjunction to control the context. When the source frame number is larger than the target frame number, a reverse propagation is triggered. This interaction allows the capability to easily propagate from a source key frame to a target key frame and does not require an intermediate step, e.g., a pop up dialog to register user inputs like source frame, target frame, propagation mode, etc.

In accordance with an embodiment of the present invention, in thumbnails, all frame view similar interactions are used to trigger a propagation command and there is not any restriction that source frame, from which the user starts the stroke and target frame, from which the users end the strokes should be key frames. This allows the capability to propagate within key frames and also allows the capability to easily propagate form a source frame to a target frame without an intermediate step.

Depth values may be applied across frames by copying a depth from the source frame to a destination frame. In this method, a depth map of the source frame is copied to all frames in-between the target frame and the source frame (including target frame).

Further, depth values are applied across frames by partially copying a depth from the source frame to a destination frame. More specifically, in accordance with an embodiment of the present invention, the user is given options to select segments, objects, a group of object, or a region from the source frame and to apply depth values to the same segments, objects, group of objects, or region present in the destination frames by copying depth values from the selected segments/objects/group of objects/region present in the source frame.

In accordance with an embodiment of the present invention, a depth copy propagation command may be triggered entirely or partially. A depth copy refers to copying a depth of a stationary object in a particular position. Bidirectional propagation methods and interactions are as described herein.

In accordance with an embodiment of the present invention, a backward propagation command is triggered by applying a predefined stroke gesture on a central primary frame in a frame view of thumbnails.

In accordance with an embodiment of the present invention, the user is presented with a dialog to input a central primary frame and end frames to trigger a propagation command.

A user is allowed to associate or group a new segment, during creation, along with a previously extracted segment. More specifically, the user selects the segmentation marker tool, selects a previously extracted segment from any of the windows, and stores this selected segment information. Further, the user draws strokes on the edit window to create a new segment. The newly created segment is given the previously stored properties of the selected segment.

In accordance with an embodiment of the present invention, along with segment information, a depth value and/or depth model information is also stored and applied to the newly created segment.

In accordance with an embodiment of the present invention, the previously stored properties to be applied on the newly created segment can be controlled by pre-defined key combinations.

In accordance with an embodiment of the present invention, a user creates a new segment by copying a stroke or a group of strokes from a source frame to a target frame. In this case, the user selects a stroke or a group of strokes in a region from the source frame. The selected stroke or group of strokes are then stored in a memory. The user selects the target frame to apply the stored strokes on the target frame. A segmentation command is then triggered on the target frame.

In accordance with an embodiment of the present invention, a user is given an option to edit the stroke, i.e., to modify, enlarge, skew, rotate, etc., before triggering the segmentation command.

Referring to FIG. 7B, three eraser modes are provided for refining a previously created segment by merging or creating new segments, performed by modifying and refining previously created segments by erasing marked strokes.

In accordance with an embodiment of the present invention, a user can copy segment information with a depth value/model along with the stroke information.

For example, clicking and dragging a mouse pointer results in erasing of previously marked strokes relative to the path of the dragged mouse pointer, after which the segmentation command is triggered to display the refined segmentation map. Further, on a touch screen device, the user uses a finger to drag.

The user creates a rectangular, circular, oval, etc., region in which previously marked strokes are erased, after which, the segmentation command is triggered to display the refined segmentation map.

FIG. 7C illustrates auto segmentation enhancement tools with which the user selects an option to perform AMBS and the user is presented with a view which shows the segment map. The user is also given an option to adjust the threshold level to define the granularity of segmentation. FIG. 7C also illustrates a segment edge strengthening and weakening tool. A threshold helps a user to decide a best result, and after auto segmentation, strengthen and weaken tools help to mark the edges that will merge the segments or divide the segment to enhance the edges of an object.

As illustrated in FIG. 7D, an interaction method for refining/modifying propagated segments is done by erasing the generated feature points. The user may group and create new segments similarly. For example, refining a previously created segment by merging or creating new segments is performed by modifying strokes by clicking and dragging a mouse pointer, which results in erasing of the previously marked strokes based on the path of the dragged mouse pointer, after which the segmentation command is triggered to display the refined segmentation map.

On a touch screen device, the user uses a finger to drag and to erase previously marked strokes.

FIG. 7E illustrates segment tools for accurately creating fine segments. Further, the segmentation weight is defined by the user by adjusting the thickness of the segment marker.

FIG. 7F illustrates a control for depth assignment with which gradient, convex, and concave depths are assigned to segmented objects. A caliper slider control includes three sub controls named start head, which defines the minimum depth value, end head which defines the maximum depth value, and a central bar whose length is proportional to the difference between the end head and the start head.

Initially, a user selects the tool. After selecting the tool, the user clicks and drags on the surface of the segment, which the user wants to assign the depth model and the direction of drawing defines the direction in which the depth values are interpolated.

The user adjusts the start and end heads of the caliper slider, by sliding it for defining the range of interpolation. Further, a depth changed command is triggered and interpolated depth is saved and depth map view is refreshed. If the user wants to adjust the depth of the entire segment/object, the user would slide the central bar. In such a case, the depth of individual pixels of the segment will also vary relative to amount at which the user slides the central bar, keeping the difference constant, i.e., a difference between the end head and start head. The depth assign command is triggered, and interpolated depth is saved and depth map view is refreshed.

In accordance with an embodiment of the present invention, the depth changed command and a adjusting the start and end heads of the caliper sliders is performed in such a way that even a single unit adjustment of any of the heads will trigger a depth assign command.

In accordance with an embodiment of the present invention, the user would slide the central bar in such a way that even a single unit adjustment of the central bar will trigger a depth changed command the user would slide the central bar.

In accordance with an embodiment of the present invention, the values of the start head and end head can also be adjusted by the user manually entering the values in an edit-box.

As illustrated in FIG. 7G, a user applies depth values by aligning a grid on to the perspective of any area in the image which was originally rectangular. Relative depth values of each point in the image are calculated from the perspective of the plane. Final depth values are represented in the image by varying grey values.

As depicted in FIG. 7H, the user is presented with a view in which depth of an object is plotted with frame/time. The user is given an option to modify depth values by modifying the depth plot curve.

In accordance with an embodiment of the present invention, the user is presented with a list of objects in the current frame/shot/project along with the depth map plot.

In FIG. 7H, depth values are edited by manipulating the depth-frame/time plot. In this method, the user is presented with a view in which depth of an object is plotted with frame/time. The user is given an option to modify depth values by modifying the depth plot curve.

In accordance with an embodiment of the present invention, the user is presented with a list of objects in the current frame/shot/project, along with the depth map plot.

As illustrated in FIG. 7I, the user is presented with a list of objects with the current frame/shot/project, along with a depth scale. For example, the user is given a slider like control to adjust depth values.

As illustrated in FIG. 7J, for copying depth values, the user selects a depth picker tool. Further, the user selects the desired pixel from which depth value is to be copied. Thereafter, the user selects the desired segment to which depth value is to be applied, and the depth value is copied to the segment.

FIG. 7K illustrates an object movement visualization graph. In FIG. 7K, the user is presented with two maps for an object. One map plots the depth of an object across time and the other map plots the objects movements. Now, user can modify the depth map with respect to the object movement visualization or depth graph.

FIG. 7L illustrates a method of editing depth values by manipulating the perspective scale visualizations for depth. Specifically, a perspective scale slider is presented to the user for assigning/modifying a depth value to an object/segment.

When the object depth is model based, e.g., gradient, convex, concave, etc., then a reference point/pixel in the object is identified and used as base point to extrapolate and assign depth for all pixels in that object.

FIG. 7M illustrates a method of assigning/editing depth by dragging the segment/object to the depth scale. In FIG. 7M, the user assigns/modifies depth values by dragging the object to a depth scale. When the object depth is model based, e.g., gradient, convex, concave, etc., then a reference point/pixel in the object is identified and used as a base point to extrapolate and to assign depth for all pixels in that object.

FIG. 7N illustrates a method for dividing and joining shots. To divide shots, the user selects a split tool from shot tools. Further, the user navigates to the frame, which is the last frame of the proposed shot. The user clicks in between frames where the shot to be split and triggers the divide command.

To join shots, the user selects a join tool from shot tools, navigates to a shot boundary, and triggers a joining command by clicking on shot boundary.

FIG. 7O illustrates clipping input media for a 2D to 3d conversion tool while importing.

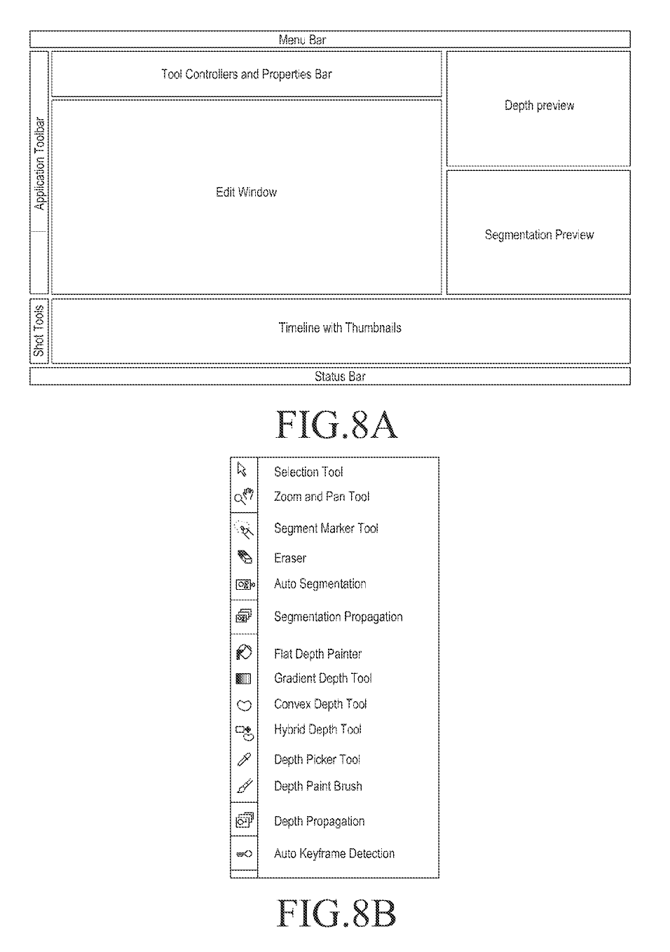

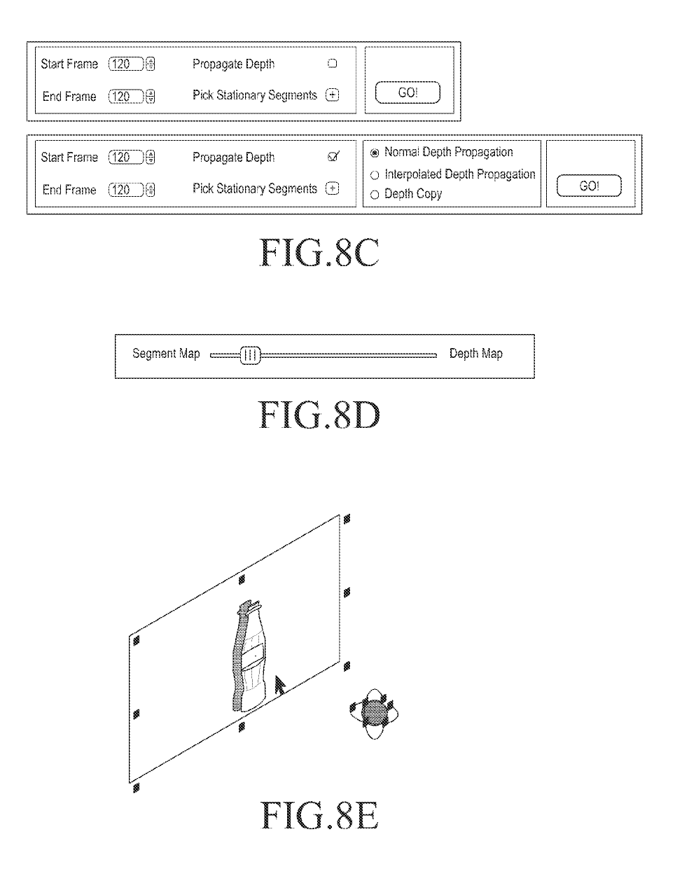

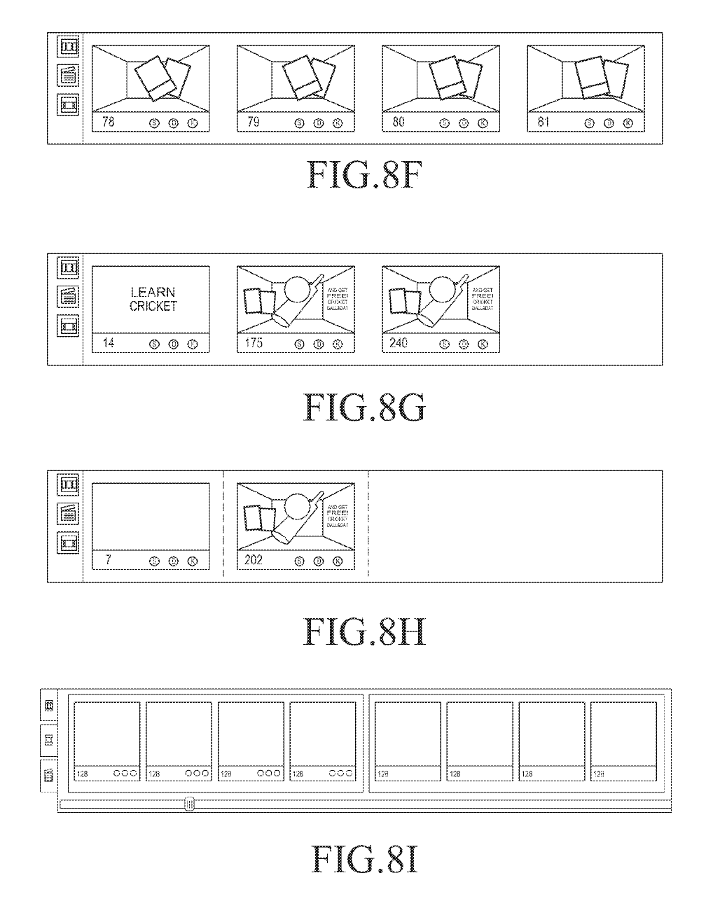

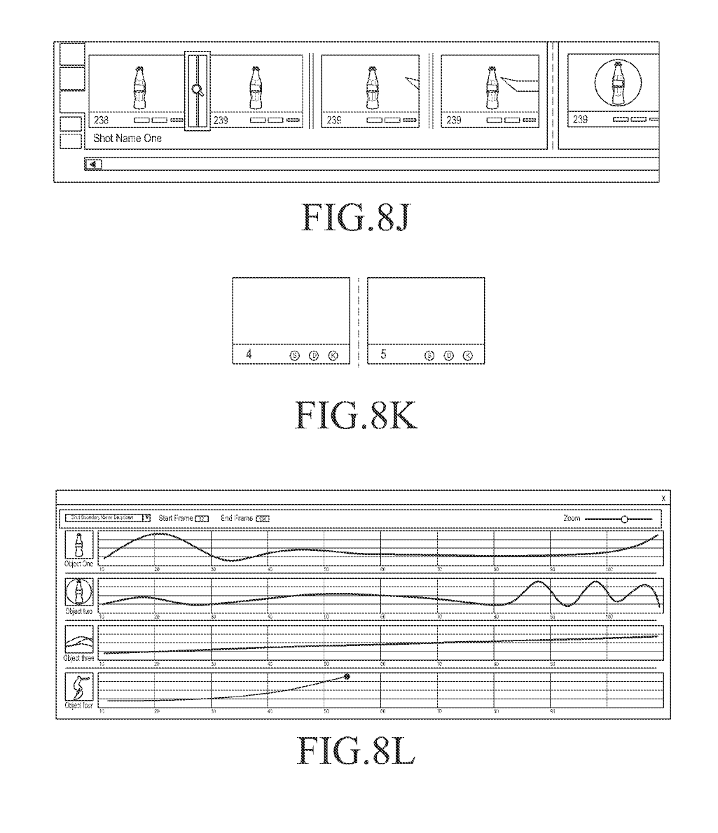

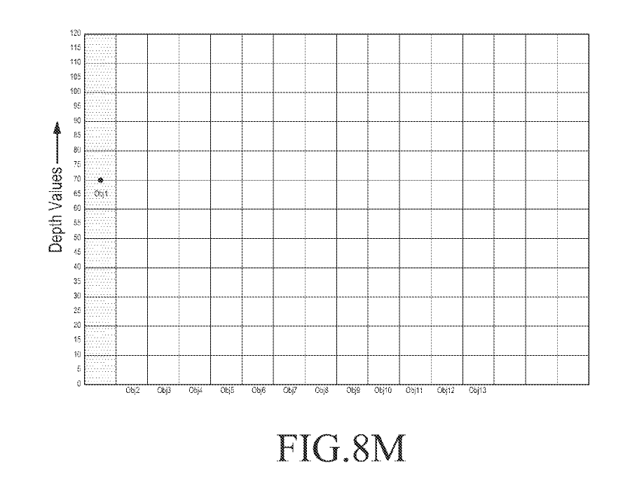

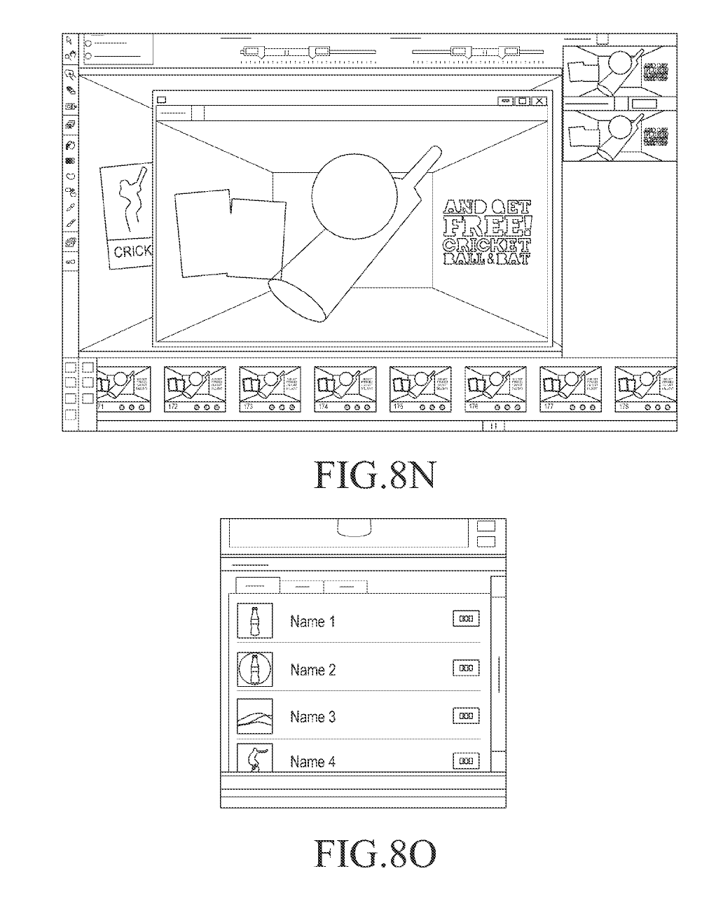

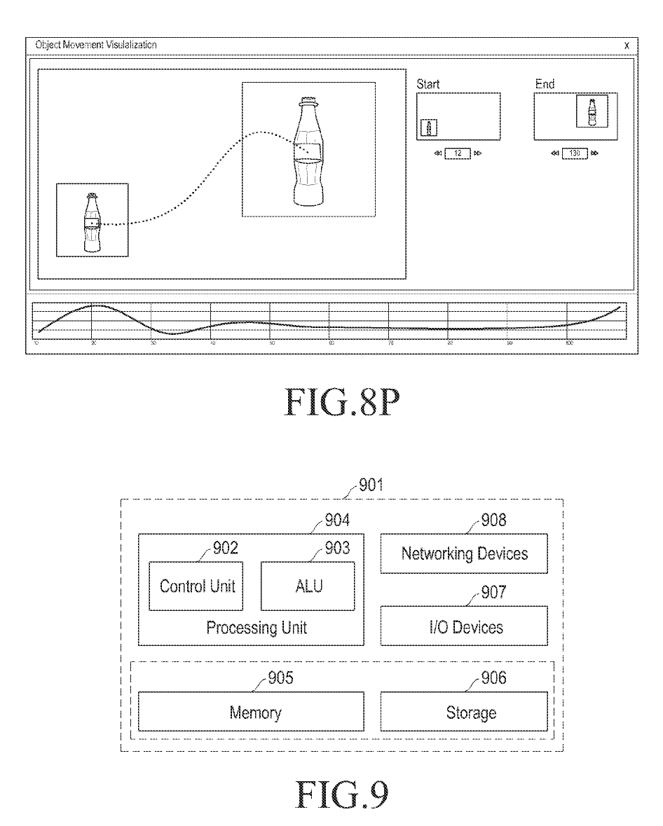

FIGS. 8A to 8P illustrate exemplary layouts of a GUI for a user-guided conversion, according to an embodiment of the present invention.

Specifically, FIG. 8A illustrates a GUI layout, which the user uses to add depth to a 2d video. A rendering of the GUI is displayed to the user on the 2D display device. The user enters commands into the computing device, e.g., through a device such as a mouse, tablet, etc. The GUI includes a menu bar, status bar, application toolbar, tool controllers and properties bar, edit window, depth preview window, segmentation preview window, timeline, and shot tools.

Although not illustrated, the menu bar includes project, edit, actions, and window and help menu options. The project menu allows the user to perform project related activities, the actions menu includes a list of actions that can be performed on content, and the help menu allows the user to obtain details about the application and to see the help content.

FIG. 8B illustrates the application tool bar. The toolbar contains graphical shortcuts to most frequently used tools and actions. The tool controller and properties bar displays contextual controls and properties related to the tool/object selected.

The edit window represents an area at which frames are edited. The depth assignment results are displayed in real-time in the depth preview window as grey scale images, where the grey values represent corresponding depth with white being the closest and black being the farthest.

Segmentation results are displayed in real-time in the segmentation Preview. The segmentation map is a representation of objects in a scene.

FIG. 8C illustrates the tool controller and properties bar, which is used for propagating depth or segments in dialogue box layout.

As illustrated in FIG. 8D, a controller is designed to blend segment map, depth map, and original image.

FIG. 8E illustrates a 3D visualization at different depth values of a frame with an orbiter tool. The orbiter tool displays a 3D visualization of a selected object with depth values. All of the frames from the movie being edited are displayed on the timeline as thumbnails. The shot-boundary information, key frame segmentation, and depth indicators are also displayed in the timeline.

FIG. 8F illustrates frames from the movie being edited, displayed on a timeline as thumbnails. Further, shot-boundary information, key frame information, segmentation information, and/or depth indicators are displayed in the timeline.

FIG. 8G illustrates the key frames of the movie, when a user clicks on any key frame. The view is changed to all frames view and scrolled to make the key frame that was clicked visible.

FIG. 8H illustrates the first key frame of shot boundaries view, when a user clicks on a frame view. The view is changed to all frames view and scrolled to make the frame that was clicked visible.

FIG. 8I illustrates a grouped thumbnail representation. The thumbnails are grouped with respect to shot boundaries and transition shots by changing the background color as depicted in the figure.

In the thumbnail key frame view, clicking in-between key frames expands the key frame showing all frames having been the clicked key frames, which are illustrated in FIG. 8J.

FIG. 8K illustrates the thumbnail status display and interactions to change status. Specifically, FIG. 8K illustrates three thumbnail status indicators. The segmentation indicator is highlighted, if segmentation command is executed for this frame. The depth indicator is highlighted, if depth assignment command is executed for this frame. Further, the key frame indicator is highlighted, if the frame is a key frame. Double clicking or a long press on the frame will toggle its key frame property. Thin color markers above scrollbar represent status.

The shot boundary tools include a Join Shot-boundary tool, a split shot tool, detect shot-boundary tool, and a mark as Gradual Transition Tool. The Join Shot-boundary tool is used to unmark a shot-boundary by clicking on the shot-boundary dividing line between frames, the split shot tool is used to mark a shot-boundary by clicking in between frames, the detect shot-boundary tool is used to run a shot-boundary detection on the entire sequence, and the mark as Gradual Transition Tool is used to mark the Gradual Transition in a sequence.

An optional window or view is illustrated in the GUI in with a depth plot in FIG. 8L. The GUI also includes optional view or windows, which can be activated by the user. When activated, these views can be docked in the GUI or can stand alone. The user is presented with a view in which depth of an object is plotted with frame or time, and as such, is given the option to modify depth values by modifying the depth plot curve.

The list view and grip view (along with sliders) is illustrated in FIG. 8M. In FIG. 8M, the user is presented with a list of objects with in the current frame or shot or project along with the depth map plot.

FIG. 8N illustrates a pop out preview window and controls. To pop out preview windows, the user can click the pop out icon on the respective preview windows. In this view, the user is also given an option to navigate from the current frame to any other fame. This enables the user to refer other frames without changing the current frame in focus. All interactions possible on the preview frames are also applicable on the pop out preview windows.

FIG. 8O illustrates an object list view. Specifically, a list view with object images and names are presented to the user, who uses tabs to filter between a frame view, a shot view, and a movie view. The frame view shows the list of all objects in current focused frame, the shot view shows list of all objects in a current shot, and the movie view.

FIG. 8P illustrates an object movement visualization and depth graph for correlation. In FIG. 8P, the user is presented with a view of two maps for an object. One map plots depths of an object across time and the other plots the object's movements. As described above, the user can modify depth using interactions.

FIG. 9 is a block diagram illustrating an apparatus 901 for converting 2D video to 3D video, according to an embodiment of the present invention. As described above, the apparatus 901 for performing the above-described methods may be a touch screen device, a mobile phone, a PDA, a laptop, a tablet, a desktop computer, etc.

Referring to FIG. 9, the apparatus 901 includes a processing unit 904 that is equipped with a control unit 902 and an Arithmetic Logic Unit (ALU) 903, a memory 905, a storage unit 906, a plurality of networking devices 908, and a plurality Input Output (I/O) devices 907. The processing unit 904 processes instructions of an algorithm, i.e., program. The processing unit 904 receives commands from the control unit 902 in order to perform processing. Further, any logical and arithmetic operations involved in the execution of the instructions are computed with the help of the ALU 903.

The apparatus 901 may include multiple homogeneous and/or heterogeneous cores, multiple Central Processing Units (CPUs) of different kinds, and special media and other accelerators. Further, the plurality of processing units 904 may be located on a single chip or over multiple chips.

The algorithm includes instructions and codes for implementation, which are stored in either the memory unit 905, the storage 906, or both. At the time of execution, the instructions may be fetched from the corresponding memory 905 and/or storage 906, and executed by the processing unit 904.

Various networking devices 908 or external I/O devices 907 may connect the apparatus 901 to a computing environment to support the implementation through the networking unit and the I/O device unit.

The above-described embodiments of the present invention can also be implemented through at least one software program running on at least one hardware device and performing network management functions to control the elements. The elements illustrates in FIG. 9 include blocks that are at least one of a hardware device, or a combination of hardware device and software module.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for converting a Two-Dimensional (2D) video to a Three-Dimensional (3D) video, the method comprising the steps of:
detecting a shot including similar frames in the 2D video;
setting a key frame in the shot;
determining whether a current frame is the key frame;
when the current frame is the key frame, performing segmentation on the key frame, assigning a depth to each segmented object in the key frame; and
when the current frame is not the key frame, performing the segmentation on non-key frames, and assigning the depth to each segmented object in the non-key frames.

2. The method of claim 1, further comprising converting the 2D video to the 3D video by assigning the depth to each segmented object.

3. The method of claim 1, wherein performing the segmentation, when the depth is assigned.

4. The method of claim 1, wherein the shot is detected by comparing a 2D video frame of the 2D video to a threshold.

5. The method of claim 1, further comprising receiving a selection of the object, based on an external object selection input by a user.

6. The method of claim 1, wherein performing segmentation on the key frame comprises:
detecting feature points in a radial direction; and
separating the object in the key frame based on the detected feature points and at least one of color information, edge information, corner information, and blob information of the key frame.

7. The method of claim 1, further comprising tracking the object to determine whether the object has been changed in a 2D video frame other than the key frame.

8. The method of claim 7, further comprising generating a segmented 2D video by correcting segmentation information, when the object has been changed in the 2D video frame other than the key frame.

9. The method of claim 8, further comprising receiving depth information for a separated object on an object basis based on at least one of a planar depth assignment, a gradient depth assignment, a convex depth assignment, a hybrid depth assignment, and an area depth assignment.

10. The method of claim 9, further comprising assigning gradually changing depth information to a specific object with respect to an extension line having a depth gradient relative to depth information of depth assignment start and end points of the specific object,
wherein the extension line is perpendicular to a line connecting the depth assignment start and end points of the specific object.

11. The method of claim 9, further comprising generating the 3D video by correcting the segmentation information, when the object has been changed.

12. An apparatus for converting a Two-Dimensional (2D) video to a Three-Dimensional (3D) video, the apparatus comprising:
a processor; and
a non-transitory memory having stored therein a computer program code, which when executed controls the processor to:
detect a shot including similar frames in the 2D video;
set a key frame in the shot;
determine whether a current frame is the key frame;
when the current frame is the key frame, perform segmentation on the key frame, assign a depth to each segmented object in the key frame; and
when the current frame is not the key frame, perform the segmentation on non-key frames, and assign the depth to each segmented object in the non-key frames.

13. The apparatus of claim 12, wherein to the apparatus convert the 2D video to the 3D video by assigning the depth to each segmented object.

14. The apparatus of claim 12, further comprising a display that displays a User Interface (UI) including a tool box,
wherein the toolbox comprises at least one of:
a planar depth assignment tool;
a gradient depth assignment tool;
a convex depth assignment tool;
a hybrid depth assignment tool; and
an area depth assignment tool.

15. The apparatus of claim 12, wherein to the processor detects the shot by comparing a 2D video frame of the 2D video to a threshold.

16. The apparatus of claim 15, wherein the processor is configured to handle transitions in a boundary of the shot, smooth a depth map of frames, before starting a transition shot and after ending the transition shot, to gradually reduce a depth disparity associated with frames at the shot boundary.

17. The apparatus of claim 12, wherein the object is selected based on an external object selection input by a user.

18. The apparatus of claim 12, wherein the segmentation of the key frame comprises detecting feature points in a radial direction, and separating the object in the key frame based on the detected feature points and at least one of color information, edge information, corner information, and blob information of the key frame.

19. The apparatus of claim 12, wherein the processor is configured to track the object to determine whether the object has been changed in a 2D video frame other than the key frame.

20. The apparatus of claim 19, wherein the processor is configured to generate a segmented 2D video by correcting segmentation information, when the object has been changed in the 2D video frame other than the key frame.

21. The apparatus of claim 12, wherein the processor is configured to receive depth information for a separated object on an object basis, based on at least one of a planar depth assignment, a gradient depth assignment, a convex depth assignment, a hybrid depth assignment, and an area depth assignment.

22. The apparatus of claim 12, wherein the processor is configured to assign gradually changing depth information to a specific object with respect to an extension line having a depth gradient relative to depth information of depth assignment start and end points of the specific object, and
wherein the at least one extension line is perpendicular to a line connecting the depth assignment start and end points of the specific object.

23. The apparatus of claim 14, wherein the processor is configured to provide the UI in a thumbnail view to propagate the segmentation and the depth values by the user, and
wherein the user select a start frame and a target frame to trigger the propagation based on a context using the tool box, and
wherein the start frame and the target frame include at least one of the key frame and a non-key frame.

24. The apparatus of claim 21, wherein the processor is configured to apply at least one of bidirectional propagation, backward propagation, and forward propagation, and
wherein the propagation is triggered using a depth copy.
